(19) United States
(12) Patent Application Publication
(10) Pub. No.: US 2017/0091631 A1
(43) Pub. Date: Mar. 30, 2017

(54) Residential HVAC System Equipment Selection Method

(71) Applicant: Kenneth George Ripberger, Metairie, LA (US)

(72) Inventor: Kenneth George Ripberger, Metairie, LA (US)

(21) Appl. No.: 15/266,380

(22) Filed: Sep. 15, 2016

Related U.S. Application Data
(60) Provisional application No. 62/233,412, filed on Sep. 27, 2015.

(51) Int. Cl. G06N 5/04

(52) U.S. Cl. CPC G06N 5/04; G06Q 50/08

(57) ABSTRACT

A new method for selection of Heating-Ventilation-and Air-Conditioning (HVAC) equipment, and the airflow settings of same, to comply with industry established limits of sizing of HVAC equipment for the residential housing construction and renovation industry. The current method utilized by mechanical contractors in the United States (and elsewhere), are guidelines set forth in the Air Conditioning Contractor's of America's “Manual S” current edition. The new method was solely developed by the inventor and is referred to, and has been sold for less than one year under the name of,

### BACKGROUND OF THE INVENTION

A residential structure, when planned for construction in a warm or humid climate, will typically also be expected to include a mechanical system to cool and dehumidify the air of the occupied space. This system must be sized, as required by building codes and governing laws in place in the jurisdiction the structure is built, to match the heat gain in British Thermal Units per Hour (Btu/Hr). This heat is the sum of the Sensible heat (change of temperature) and Latent heat (change of moisture) coming into that space from the outdoors.

All manufactured HVAC equipment is certified and tested for capacity by the Air Conditioning, Heating and Refrigeration Institute (AHRI). This is done at standard indoor and outdoor environmental conditions, to establish a numerical rating on each model of manufactured equipment for purpose of comparison between models. The only known variation in testing, reported in the manufacturer “expanded performance data charts” (Charts), is the Cubic Feet per Minute (CFM) cooling coil airflow occurring during testing of each unit.

Manufacturers also create these Charts in table format, for equipment capacities at other indoor and outdoor conditions beyond the AHRI rated capacity, with modeling formulas likely specific to their brand or model, to create other projected rates of Btu/Hr values. They do not publish these formulas.

The International Code Council is the entity whose standards are generally accepted for the construction of residential dwellings in the majority of the United States. Their publication, the International Residential Code, states:
M1401.3 Sizing. Heating and cooling equipment shall be sized in accordance with ACCA Manual S based on building loads calculated in accordance with ACCA Manual J or other approved heating and cooling calculation methodologies.

### BRIEF SUMMARY OF THE INVENTION

The ACCA Manual S method of Residential Equipment Selection is a lengthy process of repeated selection of “trial and error” attempts, to find a match of a suitable model of HVAC equipment which will satisfy the sensible and latent heat removal needs of the structure, for the outdoor and indoor conditions it will be subject to. This is done by searching the manufacturer Charts, to determine which will be the appropriate match for the target structure.

The inventor created a new method, and named the method and resulting software product Off-The-Charts (OTC) for marketing purposes, which is comprised of four steps.

In their first, and subsequent editions of Manual S, ACCA proposed a potential universal set of formulas to convert the AHRI rating of unitary HVAC residential equipment under standard conditions, to a performance capacity under other conditions. In those same manuals, ACCA stated that such a universal formula could never be created with any useful accuracy. But ACCA has never proposed using a universal formula, for the purpose of converting required capacity of a structure to an AHRI rating first. Therefore the OTC method starts out with this as a new method in its first step. The formulas will naturally change with time as they are adjusted and improved, and they are not of themselves the uniqueness or claim of the new method.

The first step of the new method requires input of the heat loss values of the structure (total and sensible), and various values of the indoor and outdoor conditions of air which it will be subject to. The mathematical formulas embedded into the method and software then projects the AHRI capacity(s) that would be required for any proposed HVAC equipment to satisfy the sensible and latent needs of that structure under those conditions which were inputted. These entries are seen on the two accompanying appendices, “StartTabOffTheChartsMulti5v158532.pdf” and “System1OffTheChartsMulti5v158532.pdf”.

The second step of the new method is for the user to select equipment of any brand, based solely on one which has a published AHRI within the value range recommended by OTC, and a matching base size indoor unit.

The third step of the new method is based on a set of projected Charts that OTC will have created for the user from the same formula constants. The user may then retrieve the actual published manufacturer Charts, and verify that the two Charts are in average numerical agreement. The user can then, with limitations, adjust to closer agreement as desired. The limitations also give the user insight as to whether the manufacturer Charts are corrupted. (See additional description below)

The fourth step of the new method, is to verify that the selected equipment satisfies the industry accepted ACCA Manual S limitations of over/under-sizing of residential HVAC equipment, as regards to total, sensible, and latent heat capacity. These established limitations are not a part of the new method. Adjustment of the planned cooling airflow quantity is also available to optimize the ratio between sensible and latent heat capacity of the equipment, to help accomplish this. While this adjustment is not new in the HVAC industry when performed as an orphan task, it is unique as a completion task in this new method.

### ADDITIONAL DETAILED DESCRIPTION OF THE INVENTION

The current ACCA Manual S methods do not, nor do any other product the inventor is aware of, advise the entire above method of steps, in selection of residential HVAC equipment selection.

The formulas built in to the product are tested for publicized accuracy at least annually for quality control. A database is created by random selection of HVAC condensing unit equipment AHRI values from different manufacturers; to then create OTC projected Charts. This is then compared to the actual manufacturer Charts, for purposes of establishing what average deviation error is being generated by OTC. This is then used to determine how much error adjustment will be allowed by the user, and also how much error will statistically qualify any submitted manufacturer Charts as an outlier by comparison to be discarded. The actual test information, has not been disclosed at this time. Additional description of this error is found on the attached appendix “Compliance OffTheChartsMulti5v158532.pdf”.

This OTC method was completed and published on Aug. 17, 2015. A screen image of each publicized tab of the marketed product sold under the OTC name (a compiled spreadsheet) is part of this provisional patent application. There are hidden tabs with proprietary information, including the formulas, which have not been disclosed at this time.

We claim:

1. The inventor created and claims this new method as an alternate to the ACCA Manual S. residential equipment selection method.

2. The process of claim 1 wherein said new method has the advantage of being an improved time-effective method for the equipment sizing requirement, and eliminates the potential of errors due to the different formats in which manufacturers currently present their sets of projected Charts, as well as the restrictions some manufacturers have on accessing the Charts, and methods in some cases; having to generate them online.
